(19) United States
(12) Patent Application Publication
(10) Pub. No.: US 2022/0412009 A1
(43) Pub. Date: Dec. 29, 2022

(54) CELLULOSIC LAMINAR ELEMENT, METHOD FOR OBTAINING SAID ELEMENT AND RECEPTACLE MADE USING SAID CELLULOSIC LAMINAR ELEMENT

(71) Applicant: TORRASPAPEL, S.A., GETAFE (MADRID) (ES)

(72) Inventor: JUAN GUINART PUIGVERT, Olot (Girona) (ES)

(21) Appl. No.: 17/756,629

(22) PCT Filed: Dec. 22, 2020
(86) PCT No.: PCT/ES2020/070813

§ 371 Date: May 27, 2022

(30) Foreign Application Priority Data
Dec. 24, 2019 (EP) 19383195.5

(51) Int. Cl. D21H 19/48; D21H 19/82; D21H 27/10; D21H 25/06; B31D 5/00

(52) U.S. Cl. CPC D21H 19/48; D21H 19/828; D21H 27/10; D21H 25/06; B31D 5/0086

(57) ABSTRACT

The present invention relates to a method for producing a coated cellulosic laminar element for disposable food and/or drinks service packaging and containers, comprising the following steps: (a) performing a first application of an aqueous dispersion of an ethylene compound and an acrylic compound on a single side of the cellulosic laminar element; (b) drying the dispersion applied in a); (c) performing, after the drying, a second application of the ethylene compound and acrylic compound to the ethylene compound and acrylic compound applied in a) on the same side; (d) drying the dispersion applied in c). The present invention also relates to a cellulosic laminar element and to a disposable foods and/or drinks service packaging and containers obtained by means of the method of the present invention.

The present invention relates to a cellulosic laminar element and to a method for obtaining said element. The present invention also relates to a receptacle using the cellulosic laminar element of the present invention.

Conventionally, plastics have been used in many different fields, including in receptacle manufacturing, due to the fact that they are light, durable and have excellent processing properties during moulding. However, plastics do not decompose very well under environmental conditions. As a result, if they are disposed of by landfill, the plastics last practically indefinitely. If they are disposed of by incineration, they cause problems such as the generation of toxic gases or they damage the incinerators. It is known that getting rid of plastics is a serious environmental issue.

To overcome this problem, therefore, active attempts have been made to develop paper and paperboard coated with a polymer layer, usually of low-density polyethylene (LDPE). However, the process of breaking down said coated paper and paperboard is very difficult because the polyethylene fibres make the paper and paperboard recycling process difficult.

For these reasons, biodegradable solutions, using paper and paperboard having layers of polylactic acid biopolymers (PLA) have been developed. However, these polymers do not solve the recycling problems. Breaking said polymers down is very expensive and composting facilities that accept biodegradable polymers are rare.

PCT patent document WO2016170229A1 discloses a coated paperboard comprising two coating layers containing two different elements. One of the layers provides a barrier function and the other layer a heat-sealing function, said other layer comprising polyvinyl acetate or styrene butadiene as a base. The aforementioned document discloses that said layers are applied simultaneously in the form of an aqueous dispersion, without any intermediate drying between the application of the two layers.

PCT patent document WO2013068382A1 discloses an aqueous polymer composition comprising an ethylene copolymer and acrylic acid, which is used as a thickening substance in the paper coating. Said composition requires at least one other coating polymer for to be used as a coating.

According to the studies carried out by the applicant, one problem when using an aqueous dispersion of an ethylene compound and an acrylic compound in paper and paperboard coatings without any other functional polymers is that said dispersion has a low solids percentage. If the solids percentage increases, the dispersion loses homogeneity. A low solids percentage leads to problems such as lack of homogeneity in the dispersion and in the barrier created, leading to possible leakage of liquid in the products made using said paper or paperboard.

The inventors of the present invention have found that, surprisingly, applying an aqueous dispersion of an ethylene compound and an acrylic compound twice with intermediate drying is sufficient for obtaining the dual functionality, i.e. a barrier and heat-sealability, without the need to add any other functional polymer to enhance the barrier effect with respect to liquids.

For these reasons, the inventors of the present invention have developed a method comprising a step of intermediate drying between the two applications of an aqueous dispersion of an ethylene compound and an acrylic compound.

Surprisingly, the impermeability results obtained by means of the method on which the present invention is based are similar to those known previously for two or more polymers. The cellulosic laminar element obtained by means of this method is so impermeable and sealable that in some products, e.g. cups, it is possible to forgo external impermeability layers on the bottom.

Before the coating is applied, a precoating comprising a binder and/or a pigment is applied. The function of said layer is to boost the functionalities of the layers to be applied subsequently, as well as to seal or close the pore structure of the paper surface.

In the present invention, the term “cellulosic laminar element” refers to a material formed by a sheet made from cellulose pulp, which is usually produced using a generally bleached pulp of ground plant fibres suspended in water, which is then dried and compacted. In the present invention, the terms “paper”, “paperboard” and “cellulosic laminar element” are synonyms and/or interchangeable.

The polyethylene-free food packaging paper is produced from high-quality lignin-free chemical pulp, which is compatible with known, relevant and industrially available paper recycling technologies.

In the present invention, the term “coated” refers to a cellulosic laminar element of which at least one side is coated with one or more layers of products that provide said element with different characteristics. The term “covered” is also used in the field with the same meaning.

In the present invention, the term “heat-sealable” refers to the ability of a polymer material to fuse when exposed to a characteristic temperature for said material, thereby acquiring adhesive properties.

In the present invention, the term “receptacle” refers to a disposable food and/or drinks service packaging and containers.

In the present invention, the term “acrylic compound” refers to any form of acrylic, preferably acrylic acid and acrylic styrenated.

In a first aspect, the present invention relates to a method for producing a coated cellulosic laminar element for disposable food and/or drinks service packaging and containers, comprising the following steps:
a) Performing a first application of an aqueous dispersion of an ethylene compound and an acrylic compound, on a single side of the cellulosic laminar element;
b) Drying the dispersion applied in a);
c) Performing, after the drying, a second application of the ethylene compound and the acrylic compound, to the ethylene compound and the acrylic compound, applied in a) on the same side;
d) Drying the dispersion applied in c).

The effective barrier effect and the sealability effect are achieved by the two applications of the same ethylene compound and acrylic compound with drying therebetween. The intermediate drying solves the sealability problems derived from a low solids percentage and/or a lack of homogeneity in the dispersion. Put another way, the intermediate drying makes it possible to obtain a layer that has a reduced grammage and excellent properties by limiting the quantity used in each of the two applications.

Preferably, the acrylic compound is selected from the group which contains acrylic acid, acrylic styrenated and a combination thereof. More preferably, acrylic compound is acrylic acid styrenated. The acrylic acid styrenated is an acrylic acid in which a styrene structure is added.

Preferably, the ethylene compound and acrylic compound aqueous dispersion contains at least 25% solids and contains less than 60% solids. More preferably, the ethylene compound and acrylic compound, contains at least 25% solids and contains less than 45% solids, and more preferably less than 35% solids. Even more preferably, the ethylene compound and acrylic compound contains between 25% and 35% solids. Even more preferably, the ethylene compound and acrylic compound contains between 26% and 28% solids.

Preferably, the pH of the ethylene compound and acrylic compound is between 7.5 and 9.5.

Preferably, the ethylene compound and acrylic compound has a maximum viscosity of 2000 mPa*s, measured by means of a Brookfield RVT rotational viscometer at 25° C. and 100 rpm (TAPPI 648 su-54 standard).

Preferably, prior to step a), said method comprises the application of a precoating of a binder and/or a pigment to one side of the cellulosic laminar element. The method of the invention can also be started from a cellulosic laminar element that already has a precoating.

Steps a) to d) of the method can be carried out on both sides or on one side only.

The application of a precoating can also be applied to both sides of the cellulosic laminar element, even if the coating is applied to one side only.

Preferably, a precoating can be applied by means of a composition comprising a binder and/or a pigment. Preferably, the binder is starch or latex. Preferably, the pigment is kaolin or talcum. Preferably, the binder on the non-covered side is starch. More preferably, the binder on the covered side is latex and the pigment on the covered side is kaolin.

The grammage of the starch layer, expressed as weight per unit area, is preferably between 1 and 2 g/m². The grammage of the latex layer and the kaolin is preferably between 6 and 7 g/m².

The starch provides good sealability with respect to the coating layer, and a good surface finish, which thus improves the aesthetic functionality. In addition, adding starch reduces the cost of the receptacle and improves the biodegradability.

The application of the precoating and of the aqueous dispersion in steps a) and c) can preferably be carried out by means of a grooved-rod coating unit.

During the drying, energy is applied to evaporate the water from the aqueous dispersion. Said drying is carried out between the two applications of the ethylene compound and the acrylic compound, and at the end of the second application. Said drying can also be carried out following the application of the precoating. Preferably, the drying of the present invention is carried out by means of infrared radiation and drying in a hot-air hood. Said drying sequence makes it possible to work with a low solids percentage without using high temperatures, which lead to the initiation of the polymerisation of the ethylene compound and acrylic compound.

Preferably, the temperature of the ethylene compound and acrylic compound layer during the drying must be below 90° C., so as to avoid activating the adhesive properties of the coating. More preferably, the temperature of the ethylene compound and acrylic compound layer during the drying must be below 70° C.

After the drying in step d) of said method, the cellulosic laminar element can be cooled. In addition, after said drying step d), a humidification step can also be carried out.

In another aspect, the present invention relates to a cellulosic laminar element for disposable foods and/or drinks service packaging and containers, comprising, on one of its sides, a coating having a polymer composition for providing the coating with barrier and heat-sealability properties, wherein the coating consists of a single layer, wherein the polymer composition consists of an ethylene compound and acrylic compound. Said dispersion composition can further comprise pH regulators, anti-foaming agents and viscosity modulators. More preferably, said copolymer composition additionally comprises only pH regulators.

The grammage of the ethylene compound and acrylic compound layer, expressed as weight per unit area, is preferably between 2 and 12 g/m². More preferably, the grammage of the ethylene compound and acrylic compound layer is between 8 and 11 g/m². Even more preferably, the grammage of the ethylene compound and acrylic compound layer is between 9 and 10 g/m². These values refer to values after drying, i.e. values when dry. Preferably, the layer is obtained by means of two applications of similar grammage. More preferably, there is a difference of 2 g/m² of grammage between both applications.

Preferably, the cellulosic laminar element has said coating layer on one side only.

Preferably, on the side to which the coating is not applied, the cellulosic laminar element has only a starch precoating. Alternatively, said side has a final coating.

The ethylene compound and acrylic compound requires a lower sealing temperature than that required by the most commonly used components, while also having sufficient sealing strength to prevent liquid leakage and using less material.

The cellulosic laminar element for disposable foods and/or drinks service packaging and containers of the present invention solves the problem of the breaking-down difficulties and is suitable for producing liquid receptacles in a wide range of high-efficiency packaging-making machines that operate at a sealing temperature in the cellulosic laminar element between 50° C. and 100° C., which is below the current compositions. This results in substantial energy savings.

In a final aspect, the present invention relates to the use of the invention to produce a receptacle. More specifically, the present invention discloses a receptacle made of the cellulosic laminar material of the present invention, comprising a first laminar piece, which forms a side wall of the receptacle, and a second laminar piece, which forms a bottom of the receptacle, wherein the first and second piece are both made from the cellulosic laminar element according to the present invention, said first and second pieces being interconnected by heat-sealing therebetween, in such a way that said coating covers the shaped internal walls of said receptacle, wherein the first piece of the receptacle made of cellulosic laminar material can be closed by contact between two of its ends along a generatrix of the side wall of the geometric figure defining the receptacle, the join being sealed by means of heat-sealing between one side of the laminar element forming the piece and the other side, and the second laminar piece, which forms the bottom of the receptacle, being sealed by means of heat-sealing with the first laminar piece forming the side wall of the receptacle.

The grammages and thicknesses of the cellulosic laminar element forming the first and second pieces may be different.

Preferably, the elements of the first and second pieces are joined by means of contact between a covered side and a non-covered side.

Preferably, said receptacles comprise just one covered side.

The receptacle obtained by means of the method of the present invention is heat-sealable and makes it possible to store the beverage safely without contamination and has a neutral odour.

In addition, it can be readily recycled in a properly paper recycling facilities and can be printed on using existing printing systems.

Unlike the coatings known currently, the excellent barrier and sealing properties of the present invention make it possible for the bottom of the receptacle to preferably not have a coating on the outside of the bottom.

A number of embodiments of the present invention will be described in more detail below with reference to the accompanying schematic drawings, in which:

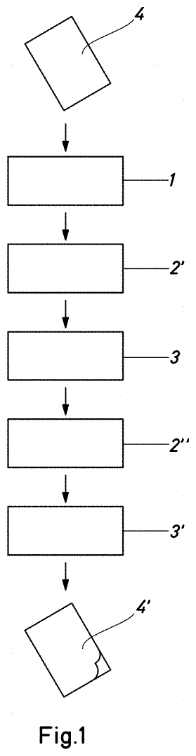

FIG. 1 is a flow diagram illustrating an embodiment of the method of the present invention.

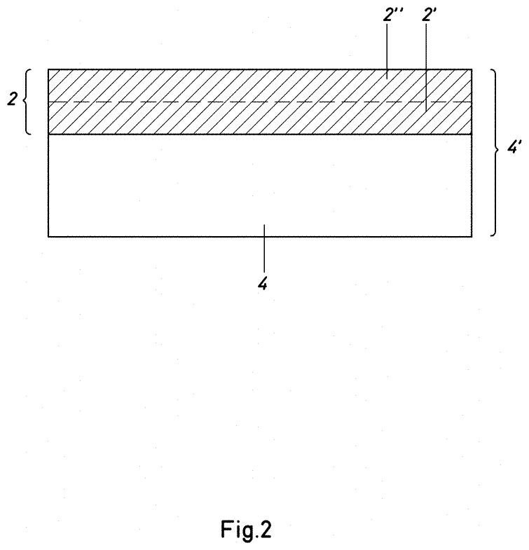

FIG. 2 is a cross section through a preferred embodiment of the coated cellulosic laminar element.

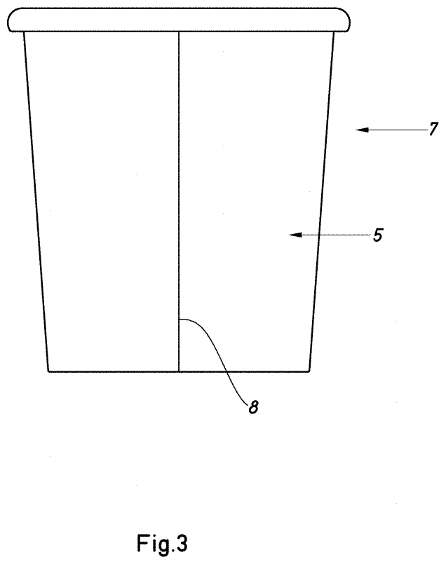

FIG. 3 is a front view of the receptacle obtained by means of the present invention.

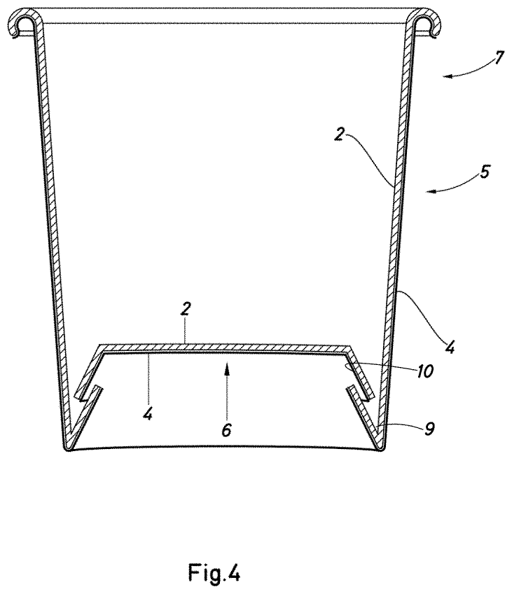

FIG. 4 is a longitudinal section through the receptacle of the present invention.

FIG. 1 is a schematic illustration by way of a flow diagram in accordance with an embodiment of the method of the present invention, shown by way of example. In a first step, a cellulosic laminar element 4 obtained from high-quality lignin-free chemical pulp compatible with recycling technologies optionally receives a precoating 1, which comprises a binder and/or a pigment, on one of its sides, followed by subsequent drying. Next, a first application of an aqueous dispersion 2′ of an ethylene compound and an acrylic compound is performed on said side of the cellulosic laminar element. In a following step 3, said dispersion is dried by means of infrared radiation and drying in a hot-air hood. A second dispersion 2″ of the same ethylene compound and acrylic compound is applied to the same side. In a subsequent step 3′, the dispersion is dried again. Lastly, a coated cellulosic laminar element 4′ is obtained.

In the above-described embodiment, steps 1 and 2′ are optionally carried out in a paper machine whilst steps 3, 2″ and 3′ are carried out in a covering machine, which may be located outside of the production line for the cellulosic laminar element.

FIG. 2 shows the structure resulting from the method of the present invention. The coated cellulosic laminar element 4′ has a single layer of coating 2 with an ethylene and acrylic compounds, said layer being obtained by two applications with intermediate drying.

FIG. 3 shows a receptacle 7 comprising a laminar piece that forms a side wall of the receptacle 5. The ends of said piece are heat-sealed together along a generatrix 8, in such a way that said coating covers the side walls of said receptacle. The laminar pieces have a coating according to the present invention on one or both sides (not shown).

In FIG. 4, it can be seen that the receptacle 7 comprises a first laminar piece, which forms a side wall 5 of the receptacle, and a second laminar piece, which forms a bottom 6 of the receptacle, the first and second pieces comprising a cellulosic laminar element 4 and an ethylene compound and acrylic compound coating 2. The seal between the two pieces is brought about by means of clamps and the application of hot air to heat the coating above the fusing temperature. The receptacle 7 has no coating on the external part of the bottom 6 of the receptacle.

In addition, it can be seen in FIG. 4 that the first piece 5 has a lower end that is folded towards the interior, thereby defining a slanted region 9. The side of said first piece 5 that has the coating 2 is joined by means of thermo-fusion to the uncoated side of the skirt 10 of the second laminar piece providing the bottom 6. Likewise, the side of the second piece 6 that is coated with the coating 2 is joined by means of thermo-fusion to the side of the first piece 5 that has the coating 2.

The present invention is additionally illustrated using the following non-limiting examples.

### EXAMPLES

### Example 1

The method for producing the coated cellulosic laminar element according to the invention was used to produce a coated cellulosic laminar element. The paper was obtained from lignin-free chemical pulp, with a grammage of between 150 and 350 g/m² and thicknesses of between 250 and 450 μm depending on the grammage. Starch was applied to one side, providing the coated cellulosic laminar element with good sealability and a good aesthetic finish on the surface. On the other side, a precoating of latex was applied to one side of the paper to between 6 and 7 g/m² using a grooved-rod unit. Next, a first layer of an ethylene and an acrylic acid aqueous dispersion containing 26% solids and having a pH of between 7.5 and 9.5 and a grammage of between 4 and 5 g/m² was applied to the same side using a grooved-rod or blade unit. The aqueous dispersion was dried by means of infrared radiation and drying in a hot-air hood, aiming for the temperature of the dispersion to not exceed 70° C. so as to avoid the need for a subsequent drying step. A second layer of the aqueous dispersion of the same ethylene and acrylic acid was applied to said same layer to between 6 and 7 g/m² using a grooved-rod or blade unit. Said dispersion was dried by means of the same technique applied earlier. The combination of the coating on one side with the starch provides the coated cellulosic laminar element with good sealability.

In this way, a structure according to FIG. 2 was obtained.

It was verified that the coated cellulosic laminar element obtained was readily recyclable without requiring any intermediate processes or treatments.

### Example 2

Said cellulosic laminar element produced in Example 1 was used by the receptacle producer to prepare receptacles similar to those in FIGS. 3 and 4. The sealing properties of the receptacles were excellent and the barrier properties were also very good given that the addition of coffee at a temperature of 90° C. did not result in any leakage through the bottom or through the side walls of the receptacle for 20 minutes. After these 20 minutes, the coffee cooled down, and there was no leakage once it had cooled either.

### Example 3

The method for producing the coated cellulosic laminar element according to the invention was used to produce a coated cellulosic laminar element. Starch was applied to one side, providing the coated cellulosic laminar element with good sealability and a good aesthetic finish on the surface. On the other side, a precoating of latex was applied to one side of the paper to between 6 and 7 g/m² using a grooved-rod unit. Next, a first layer of an ethylene and an acrylic styrenated aqueous dispersion containing 45% solids and having a pH of between 7.5 and 9.5 and a grammage of between 4 and 5 g/m² was applied to the same side using a grooved-rod or blade unit. The aqueous dispersion was dried by means of infrared radiation and drying in a hot-air hood, aiming for the temperature of the solution to not exceed 90° C. so as to avoid the need for a subsequent drying step. A second layer of the aqueous dispersion of the same ethylene and acrylic styrenated was applied to said same layer to between 6 and 7 g/m² using a grooved-rod or blade unit. Said dispersion was dried by means of the same technique applied earlier. The combination of the coating on one side with the starch provides the coated cellulosic laminar element with good sealability.

1. A method for producing a coated cellulosic laminar element for disposable food and/or drinks service packaging and containers, the method comprising:
a) Performing a first application of an aqueous dispersion of an ethylene compound and an acrylic compound on a single side of the cellulosic laminar element;
b) Drying the dispersion applied in a);
c) Performing, after the drying, a second application of the ethylene compound and acrylic compound to the ethylene compound and acrylic compound applied in a) on the same side;
d) Drying the dispersion applied in c).

2. The method according to claim 1, wherein the acrylic compound is selected from the group which contains acrylic acid, acrylic styrenated and a combination thereof.

3. The method according to claim 1, wherein, prior to step a), a precoating of a binder and/or a pigment is applied to one side of the cellulosic laminar element.

4. The method according to claim 1 wherein, prior to step a), a precoating of a binder and/or a pigment is applied to both sides of the cellulosic laminar element.

5. The method according to claim 1, wherein drying is carried out following the application of the precoating.

6. The method according to claim 1, wherein the ethylene compound and acrylic compound aqueous dispersion contains at least 25% solids.

7. The method according to claim 1, wherein the ethylene compound and acrylic compound aqueous dispersion contains less than 60% solids.

8. The method according to claim 1, wherein the drying is carried out by means of infrared radiation and drying in a hot-air hood.

9. The method according to claim 1, wherein the temperature of the ethylene compound and acrylic compound layer during the drying lower than 70° C.

10. A cellulosic laminar element for disposable food and/or drinks service packaging and containers, comprising, on one of its sides, a coating having a polymer composition for providing the coating with barrier and heat-sealability properties, wherein the coating consists of a single layer, the polymer composition consisting of an ethylene compound and acrylic compound.

11. The cellulosic laminar element for disposable food and/or drinks service packaging and containers according to claim 10, wherein said cellulosic laminar element is obtained by means of the method comprising:
a) Performing a first application of an aqueous dispersion of an ethylene compound and an acrylic compound on a single side of the cellulosic laminar element;
b) Drying the dispersion applied in a);
c) Performing, after the drying, a second application of the ethylene compound and acrylic compound to the ethylene compound and acrylic compound applied in a) on the same side;
d) Drying the dispersion applied in c).

12. The cellulosic laminar element for disposable food and/or drinks service packaging and containers according to claim 10, wherein the grammage of the ethylene compound and acrylic compound is between 2 and 12 g/m².

13. The cellulosic laminar element for disposable food and/or drinks service packaging and containers according to claim 10, wherein the grammage of the ethylene compound and acrylic compound is between 9 and 10 g/m².

14. The cellulosic laminar element for disposable food and/or drinks service packaging and containers according to claim 10, wherein said cellulosic laminar element has said coating layer on one side only.

15. The cellulosic laminar element for disposable food and/or drinks service packaging and containers according to claim 10, wherein the side to which the coating is not applied has only a starch precoating.

16. A receptacle made of a cellulosic laminar material, comprising a first laminar piece, which forms a side wall of the receptacle, and a second laminar piece, which forms a bottom of the receptacle, wherein the first and second piece are both made from the cellulosic laminar element according to claim 10, said first and second pieces being interconnected by heat-sealing therebetween, in such a way that said coating covers the shaped internal walls of said receptacle and the first piece is closed by contact between two of its ends along a generatrix of the side wall of the geometric figure defining the receptacle, the join being sealed by means of heat-sealing between one side of the laminar element forming the piece and the other side, and the second laminar piece, which forms the bottom of the receptacle, being sealed by means of heat-sealing with the first laminar piece forming the side wall of the receptacle.
